(19) United States
(12) Patent Application Publication
(10) Pub. No.: US 2006/0004752 A1
(43) Pub. Date: Jan. 5, 2006

(54) Method and system for determining the focus of a document

(75) Inventors: Nadav Harel, Haifa (IL); Einat Amitay, Shimshit (IL); Ron Sivan, Haifa (IL)

Correspondence Address: RICHARD M. GOLDMAN, 371 ELAN VILLAGE LANE, SUITE 208, CA, 95134, US

(73) Assignee: International Business Machines Corporation

(21) Appl. No.: 11/165,527

(22) Filed: Jun. 23, 2005

(30) Foreign Application Priority Data
Jun. 30, 2004 (GB) 0414623.9

(51) Int. Cl. G06F 7/00

(52) U.S. Cl. 707/6

(57) ABSTRACT

A method and system for determining the focus of a document are provided. Candidate topics in the form of topic nodes in a hierarchy of topics are input into a focus determining algorithm. For each candidate topic node, a score is allocated to the topic of each level of the hierarchy of the topic node , the scores for each topic are summed and one or more topics are determined to be the focus of the document based on the scores. The scores allocated to the topic of each parent level of the hierarchy of the topic node are progressively lower for the topic of each parent level of the hierarchy. The candidate topics may be provided by identifying occurrences of references to a topic in a document, providing a plurality of possible topics in the form of topic nodes in a hierarchy of topics, and, for each identified occurrence of a reference to a topic, determining the appropriate topic node and adding the topic node to the candidate topics.

### BACKGROUND

1. Field of the Invention

This invention relates to the field of content determining systems. In particular, the invention relates to determining the focus of a document.

2. Background Art

Identifying the focus of a text document such as a Web page, a news article, an email, etc. can be beneficial in a large number of situations. One such situation is in data mining systems in which information is automatically searched for through a large number of documents. A means of determining a focus of a document automatically in order to enable a search by focus topic would be extremely useful.

The example of geographic focus is used throughout this document to illustrate a type of clearly defined focus which can be expressed in hierarchical form. However, this should not be construed as limiting the scope of this disclosure and is merely used as an example of a type of focus. The types of focus are wide-ranging and include any topic which can be expressed in a hierarchy.

Using the example of geographic focus, if a means of identifying the focus of a document is provided, users may add geographic criteria to queries in search engines and the search engines would be able to process the query intelligently. The geographic distribution of matching documents could be displayed or mining could be narrowed to a certain geographic region (for example, to only documents that talk about England). Correlation between mentions of place names, or place names and other terms, could be analysed, for example, to find which places are most associated with fashion, vacations, good food, etc.

To accomplish the goal of determining the focus of a document, an understanding of the topics in a document is needed. This is usually extracted from the references to the topics the document refers to; however, such references may be ambiguous. In the case of geographic topics, confusion can arise if there are several places with the same name or a place name is also a common word, an individual's name, etc.

A known system for determining the topical focus of a text passage (its “theme”) is described in a pair of U.S. Pat. Nos. 5,887,120 and 6,199,034 entitled “Methods and apparatus for determining theme for discourse”, by Kelly Wical assigned to Oracle Corporation (referred to as Wical's patents). An algorithm described by these patents determines the theme of a document, selected from various hierarchies of all possible themes referred to as “Ontologies”. Additionally, these ontologies associate each theme with some “terms” (words or phrases); the presence of such terms in the text is taken as an indication that the associated theme is being discussed.

The process described in Wical's patents starts by full grammatical analysis of a document. Then, for each sentence, a candidate focus set referred to as a “theme vector” is formed, consisting of the theme related to each unambiguous content word, together with some “theme strength” which is decided by grammatical knowledge and other heuristics. The theme strength is also added to the hierarchical parent of each focus in the candidate set referred to as its “theme concept”. If such a parent becomes strong enough, it is declared a focus referred to as a “theme term” in its own right and is added to the candidate focus set as a derived focus. This procedure is then applied recursively.

It is clear that Wical's algorithm, when used with a geographic hierarchy find a geographic focus. However, there are two main drawbacks with this prior art algorithm and its results.

Firstly, when given a test document that mentions the European cities of Paris, London, Berlin, Rome and Amsterdam, a single geographic focus would be desired of “Europe”. However, Wical's algorithm will not make such a generalization that involves going up two hierarchy levels, because it works by “promoting” topics one hierarchy level at a time. When it considers Paris's parent, France, the latter is not strong enough to be promoted to be a “theme term” (i.e., be considered for being a focus) because only one French city is mentioned. Similarly, the UK, Germany, Italy and the Netherlands will also not be promoted, and consequentially their parent—Europe—will never be considered.

Secondly, the Wical's algorithm does not make the distinction that a region and another region which encloses it cannot both be foci of the same document. For example, a document usually cannot be both about London and about England—it is either about England (and also mentioning London, as its capital), or about London (and also mentioning England, the country that London is in). This kind of situation—a document about London also mentioning England, and vice versa—is very common in the geographic domain. Wical's algorithm and its resulting focus set (“theme vector”) may contain such overlapping regions.

### SUMMARY OF THE INVENTION

An aim of the present invention is to find a document's focus or plurality of foci given an unambiguous list of potential subjects in the form of words or phrases in the document selected from a hierarchy of topics. This may be applied to a geographic context in which a document's geographic focus is determined given the unambiguous list of all geographic mentions in it.

The focus determination may be useful for various products that do UIM (unstructured information management), text analysis, speech analysis, search, and more.

Determining the focus of a document may involve ignoring topics mentioned incidentally, and choosing a hierarchy level of topic which is broad enough to cover most of the document's discussion, without being overly broad. The aim of the focus determination can be more easily understood by looking at a few example decisions (again using the geographic focus example) that the focus determination should make.
A document that mentions “London, England” five times and “Paris, France” once, is probably focusing on London, and that city should be declared its only focus.
A document that mentions London, Manchester and Bristol (all determined to be references to the cities in England) should get a focus of England. A document that mentions Paris, Berlin, London and Madrid (all determined to refer to the European cities by these names) should get a focus of Europe.
A document that mentions “London, England” five times and “England” once is about London, while a document that mentions England five times and London only once, is about England.

According to a first aspect of the present invention there is provided a method for determining the focus of a document, comprising: providing candidate topics in the form of topic nodes in a hierarchy of topics; for each candidate topic node, allocating a score to the topic of each level of the hierarchy of the topic node; summing the scores for each topic; and determining one or more topics as the focus of the document based on the scores.

Preferably, allocating a score to the topic of each parent level of the hierarchy of the topic node allocates a progressively lower score for the topic of each parent level of the hierarchy of the topic node. The progression may be determined by a decay factor which may be a predetermined constant or variable.

The method may include identifying occurrences of references to a topic in a document; providing a plurality of possible topics in the form of topic nodes in a hierarchy of topics; for each identified occurrence of a reference to a topic, determining the appropriate topic node; and adding the topic node to the candidate topics. Determining the appropriate topic node may provide an indication of the level of confidence that the reference relates to the topic node and the scores may be based on the level of confidence.

Determining one of more topics as the focus of the document may include one or more of: selecting a predetermined number of topics with the highest scores; selecting topics with a score above a predetermined threshold; and disregarding topics in a hierarchy above or below a topic already selected as a focus.

Providing a plurality of possible topics in the form of topic nodes in a hierarchy of topics may include providing a list of possible forms of reference for each topic, and, optionally, additional information relating to the topic.

Determining the appropriate topic node may include disambiguating references to a topic by applying heuristics to each reference to a topic including one or more of: evaluating the words surrounding a reference; applying additional information stored in relation to predefined references; and evaluating a context of the reference in the document.

In one embodiment of the method, the topics are geographic topics and the topic hierarchies include encompassing regions.

According to a second aspect of the present invention there is provided a system for determining the focus of a document, comprising: means for providing candidate topics in the form of topic nodes in a hierarchy of topics; means for allocating a score for each candidate topic node to the topic of each level of the hierarchy of the topic node; means for summing the scores for each topic; and means for determining one or more topics as the focus of the document based on the scores.

The means for allocating a score to the topic of each parent level of the hierarchy of the topic node allocates a progressively lower score for the topic of each parent level of the hierarchy of the topic node.

The system may include: means for identifying occurrences of references to a topic in a document; a record of a plurality of possible topics in the form of topic nodes in a hierarchy of topics; means for determining, for each identified occurrence of a reference to a topic, the appropriate topic node in the record; and means for adding the topic node to the candidate topics. The means for determining for each identified occurrence of a reference to a topic, the appropriate topic node may include means for providing an indication of the level of confidence that the reference relates to the topic node and the means for allocating a score may be based on the level of confidence.

The means for determining one of more topics as the focus of the document may include one or more of the following: means for selecting a predetermined number of topics with the highest scores; means for selecting topics with a score above a predetermined threshold; and means for disregarding topics in a hierarchy above or below a topic already selected as a focus.

The record of a plurality of possible topics in the form of topic nodes in a hierarchy of topics may include a list of possible forms of reference for each topic and, optionally, additional information relating to the topics.

The means for determining, for each identified occurrence of a reference to a topic, the appropriate topic node in the record may include means for disambiguating references to a topic. The means for disambiguating references to a topic may apply heuristics to each reference to a topic including one or more of: evaluating the words surrounding a reference; applying additional information stored in relation to predefined references; and evaluating a context of the reference in the document.

In one embodiment of the system, the topics are geographic topics and the topic hierarchies include encompassing regions.

The system may be a text mining application and the document may be a text document, for example, a web page.

According to a third aspect of the present invention there is a computer program product stored on a computer readable storage medium, comprising computer readable program code means for determining the focus of a document, the code means performing the steps of: providing candidate topics in the form of topic nodes in a hierarchy of topics; for each candidate topic node, allocating a score to the topic of each level of the hierarchy of the topic node; summing the scores for each topic; and determining one or more topics as the focus of the document based on the scores.

### THE FIGURES

Embodiments of the present invention will now be described, by way of examples only, with reference to the accompanying drawings in which:

FIG. 1 is a block diagram of a general purpose computer system in which a system in accordance with the present application may be implemented;

FIG. 2 is a schematic block diagram of a system in accordance with the present invention;

FIG. 3 is a representation of a hierarchy of topics in accordance with the present invention;

FIG. 4 is a schematic block diagram of an embodiment of the system of FIG. 2;

FIG. 5 is flow diagram of a method in accordance with the present invention; and

FIG. 6 is a flow diagram of a method in accordance with the present invention.

### DETAILED DESCRIPTION

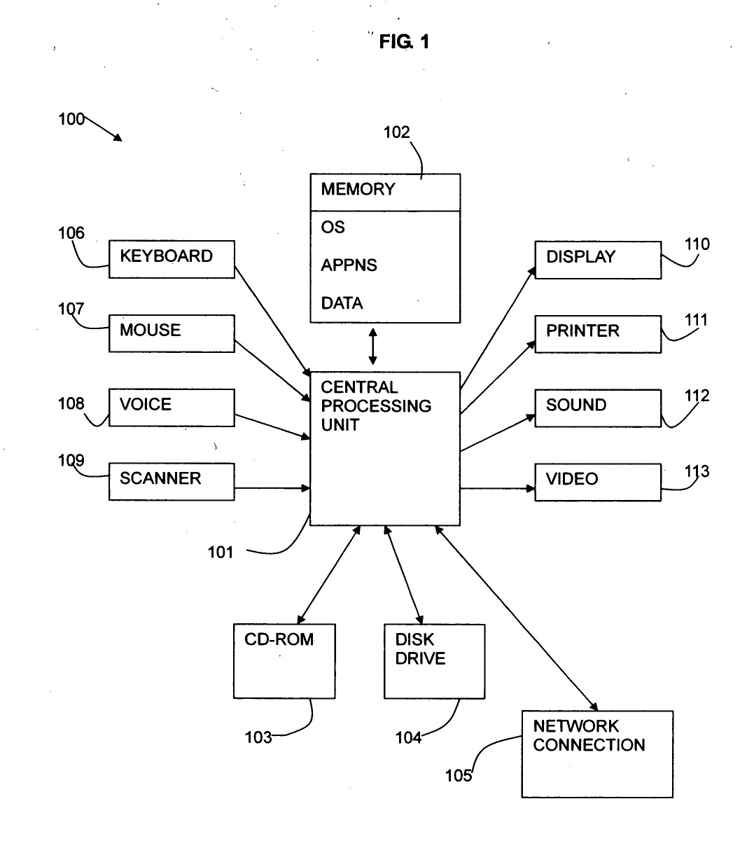

Referring to FIG. 1, a general embodiment of a computer system 100 is shown in which the present invention may be implemented. A computer system 100 has a central processing unit 101 with primary storage in the form of memory 102 (RAM and ROM). The memory 102 stores program information and data acted on or created by the programs. The program information includes the operating system code for the computer system 100 and application code for applications running on the computer system 100. Secondary storage includes optical disk storage 103 and magnetic disk storage 104. Data and program information can also be stored and accessed from the secondary storage.

The computer system 100 includes a network connection means 105 for interfacing the computer system 100 to a network such as a local area network (LAN) or the Internet. The computer system 100 may also have other external source communication means such as a fax modem or telephone connection.

The central processing unit 101 includes inputs in the form of, as examples, a keyboard 106, a mouse 107, voice input 108, and a scanner 109 for inputting text, images, graphics or the like. Outputs from the central processing unit 100 may include a display means 110, a printer 111, sound output 112, video output 113, etc.

In a distributed system, a computer system 100 as shown in FIG. 1 may be connected via a network connection 105 to a server on which applications may be run remotely from the central processing unit 101 which is then referred to as a client system.

An application is provided in accordance with the present invention which determines the focus of a document. The document may take the form of any text document such as a word processed document, a scanned document, an email message, a Web page, or a published article, etc. The application may be provided as part of a data or text mining application, a search engine of an Internet access program, or as part of another form of text indexing and retrieving program. The application may run on a computer system or from a storage means in a computer system, may form part of the hardware of a computer system or may be run remotely via a network connection.

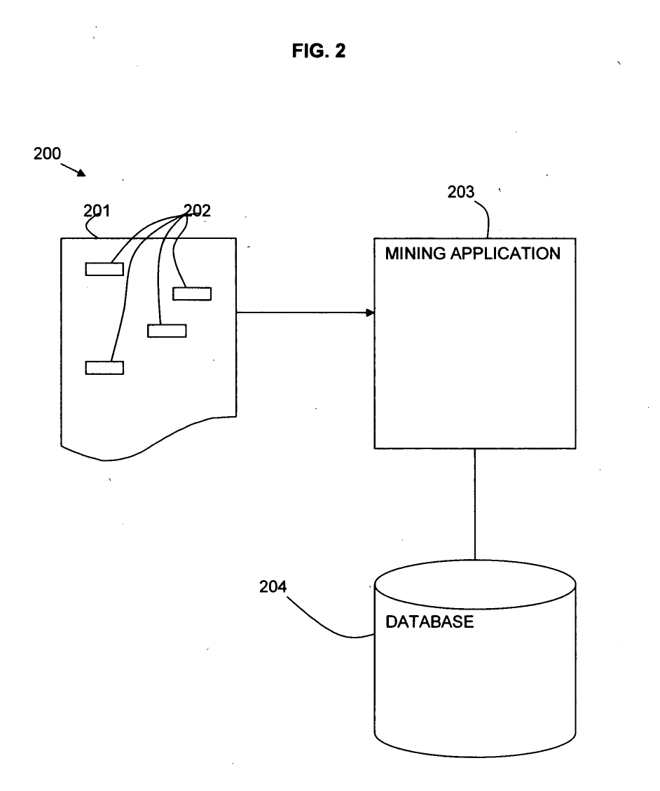

Referring to FIG. 2, a system 200 for determining the focus of a document is shown in which an input document 201 contains topic references 202 in the form of words or phrases. A text mining application 203 is provided which scans the input document 201 and identifies instances of topic references 202. A database 204 of topic references 202 is provided which is accessed by the mining application 203. The database 204 contains hierarchies of topics to which the references 202 may relate. The mining application 203 obtains a list of topic hierarchies for the references 202. The mining application 203 can then perform a focus-determining algorithm to determine one or more foci of the input document 201 based on the topic references 202.

An embodiment of the present invention is described in the context of the geographic focus of documents. This is an example of a type of focus and the present invention may equally be applied with other forms of topics.

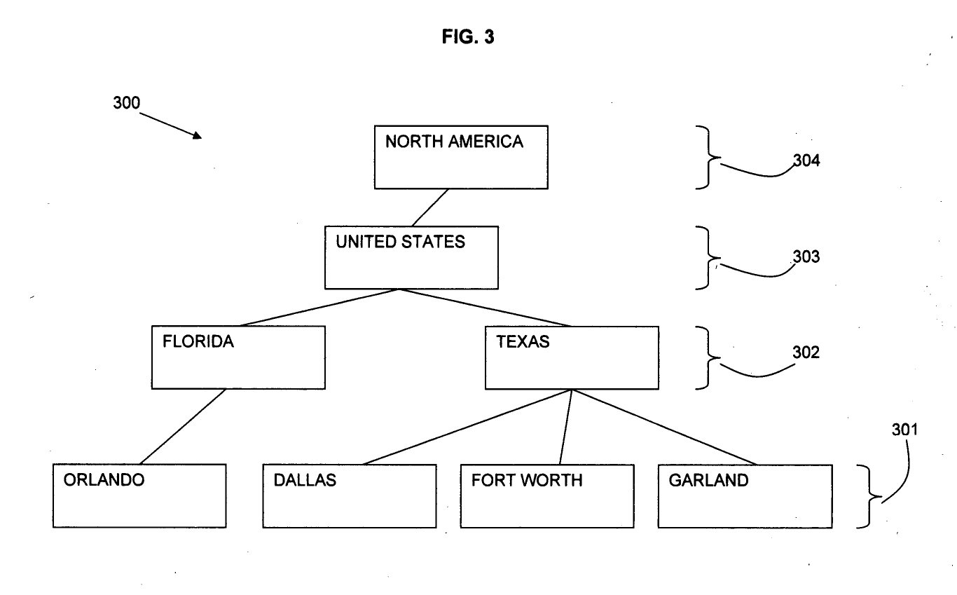

The mining application 203 finds geographic references (which may be in the form of names, abbreviations, etc.) in an input document 201 and disambiguates the geographic references, where necessary. Disambiguation means determining a unique place that the reference relates to and assigning a taxonomy node to the reference in the text that is deemed to refer to the unique place. Like an address, a taxonomy node indicates a single, unambiguous place by hierarchically specifying its name and the names of all the regions encompassing it. For example, FIG. 3 shows taxonomy nodes for geographic places which are illustrated in the form of a tree hierarchy 300. Each block in the tree hierarchy 300 is a taxonomy node.

A first level 301 provides names of specific towns with the following taxonomy nodes:
“Orlando/Florida/United States/North America”;
“Dallas/Texas/United States/North America”;
“Fort Worth/Texas/United States/North America”;
“Garland/Texas/United States/North America”.

The second level 302 gives the states in which the towns are situated. This has the following taxonomy nodes:
“Florida/United States/North America”;
Texas/United States/North America”.

The third level 303 gives the country, which has the following taxonomy node:
“United States/North America”.

Finally, the fourth level 304 gives the continent, which has the taxonomy node of:
“North America”.

The use of taxonomy nodes can provide a user with powerful search options. For example, searching for a topic identified by the taxonomy node of “France/Europe” could return a document that does not mention France explicitly but mentions names of cities determined to be in France.

A list of geographic places is stored in a database 204, with each geographic place having a unique taxonomy node, a plurality of references which may be used to refer to the geographic place in a document, and other pertinent information relating to the geographic place. The database 204 for the geographic case is referred to as a gazetteer.

The gazetteer contains a hierarchical view of the world, divided, in this embodiment, into continents, countries, states (where appropriate), and cities. This hierarchy associates each geographic place with a taxonomy node defined by the hierarchy. Each place can be associated with a number of references in the form of names and/or abbreviations. For example, “Alabama”, “AL” and “Ala.” are all names of the same state. World coordinates and a population estimate may also be assigned to each place as these may be used in the disambiguation algorithm.

The mining application 203 finds all possible geographic references 202 in each input document 201. The list of words to find is the list of all the possible references to places in the gazetteer. Rules can be applied to improve the productivity of the finding process. For example, short abbreviations are ignored since, in many cases, they are too ambiguous, such as IN (for Indiana or India), AT (for Austria). However, such abbreviations may be used to help disambiguate other reference finds, such as “Gary, IN”.

A disambiguation algorithm in the mining application 203 sequentially applies several heuristics to each reference find in order to allocate a confidence estimate in the form of a probability that the reference is in fact a reference to the place identified in the taxonomy node selected. For example the following rules may be applied in a disambiguation algorithm:
If the tokens in the vicinity of the reference can uniquely qualify it, as in “IL” immediately following a reference of “Chicago”, the mining application 203 assigns this unique meaning to the reference with a confidence range of 0.95-1 to reflect its high level of certainty.
Unresolved references are assigned a default meaning to the place with the largest population, but the confidence of this assignment is set to a low level, for example 0.5.
In the case of the document having multiple references of the same form where only one is qualified, the meaning of the qualified reference is delegated to the others. The assignment is given a confidence in the range of 0.8-0.9 depending on whether the delegated meaning matches the reference's default meaning.
A disambiguated context for the references that are still unresolved is sought (those whose confidence is below 0.7). A context is a region in whose confines most unresolved references become unique.

Once the correct meaning of every geographic reference mentioned in the input document has been determined, the geographic places that are the actual focus are determined as opposed to the incidental mentions of geographic places. This determination of a focus is carried out by a focus-determining algorithm in the mining application 203.

Each geographic reference 202 in an input document 201 is interpreted as referring to a taxonomy node in the geographic hierarchy, textually represented by a taxonomy string of the form “Paris/France/Europe”. Each reference 202 adds a certain score to the importance of this taxonomy node in the input document 201, while adding progressively lower scores to the taxonomy nodes of the enclosing regions (i.e., the nodes above it in the hierarchy) “France/Europe” and “Europe”. The scores contributed by all references 202 in the input document 201 are summed to the various taxonomy nodes, and then the taxonomy nodes are sorted by their importance score. The places represented by the taxonomy nodes given top scores are determined to be most in focus. Places that are already part of or enclose a higher scoring place are ignored, as well as places whose importance score is not high enough as determined by a threshold.

The reason that places contribute less score to their enclosing regions is that this allows the more specific place to “win” if it is the only place mentioned in this region, while permitting the region to be chosen as a focus if several different places in it are mentioned with no emphasis on any of them.

If several cities from the same region are mentioned in a document, this might mean that this region is the focus. For example, a document mentioning San Francisco (Calif.), Los Angeles (Calif.) and San Diego (Calif.) can be said to be about California. A document mentioning San Jose (Calif.), Chicago (Ill.) and Louisiana can be said to be about the United States. A document that is predominantly about the United States with a single mention of Paris, France can still be said to be only about the United States. Repeated mentions of the same place should count, for example, a document mentioning the state of California five times is just as likely to be about California as a document mentioning five different cities in California.

It may not be possible to determine that a document has only one focus. For example, two different countries might be repeatedly mentioned in a news story. In such cases, several geographic regions should be listed as foci. However, many places should still be coalesced into one region as much as possible before declaring the foci, so that a document that lists the 50 states of the United States will not be said to have 50 separate foci, but rather one focus—the United States. The other extreme should be avoided as well: if a small region is the real focus of a document, a larger region should not unnecessarily be reported. It is very easy, but not very productive, to report several continents as being the “focus”.

The focus-determining algorithm assumes that all geographic references in the input document have already been disambiguated correctly. When the disambiguation algorithm makes a bad guess, it should give it a low confidence estimate. In finding the focus, the confidence estimates are taken into account, giving higher weight to information coming from places with higher confidence weights.

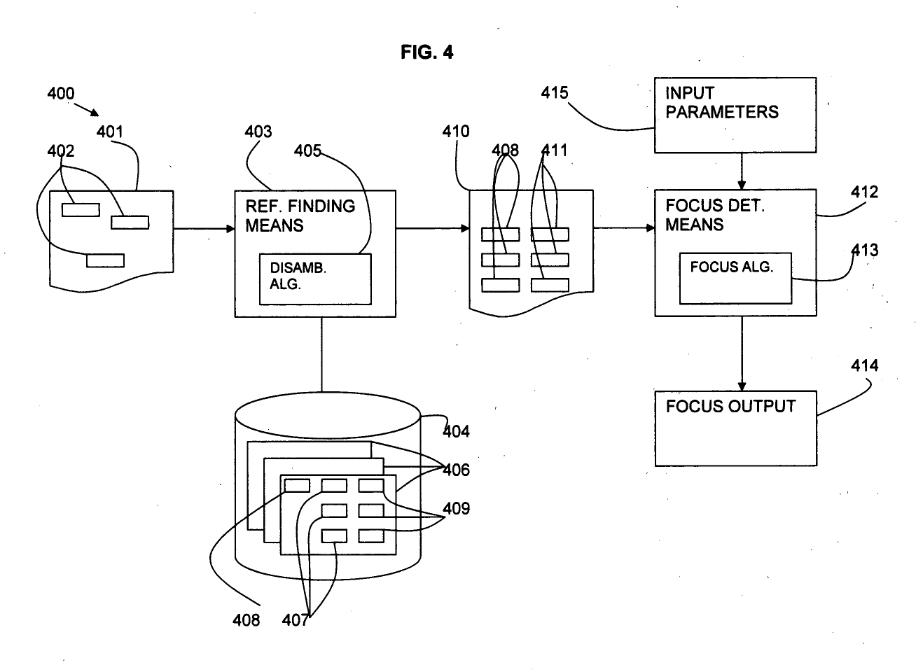

Referring to FIG. 4, an embodiment of a system 400 for determining the focus of a document is shown in the context of geographic places.

An input document 401 contains references 402 to geographic places. The references 402 may be names and/or abbreviations and may or may not be qualified with an associated reference. A reference finding means 403, which may be part of a mining application, scans the input document 401 for the references 402.

A database in the form of a gazetteer 404 contains records of geographic places 406 with each place have a plurality of references in the form of names and/or abbreviations 407 associated with the place 406. Each geographic place 406 has a taxonomy node 408 in the form of a hierarchy of regional levels uniquely identifying the geographic place 406. In addition, the records of the geographic places 406 have associated information 409 such as population information, world coordinates and information relating to associated references which may be found in the vicinity of a reference 402 (for example, a state abbreviation next to a city reference).

The reference finding means 403 uses all the references 407 identified in the gazetteer 404 to scan the input document 401. The result is a list of references 402 identified in the input document 401. A disambiguation algorithm 405 sequentially applies several heuristics to each occurrence of a reference 402 found in the input document 401. The disambiguation algorithm 405 may also apply the information 409 provided in relation to each geographic place 406 identified by a reference 402. The disambiguation algorithm 405 allocates a taxonomy node 408 to each occurrence of a reference 402 in the list of references identified in the input document 401 together with a confidence estimate which provides an indication of the level of certainty that a reference 402 relates to the geographic place 406 uniquely identified by the allocated taxonomy node 408.

The output from the reference finding means 403 is a list 410 of taxonomy nodes 408 identifying the geographic places 406 referenced 402 in the input document 401 with each taxonomy node 408 having a confidence estimate 411. The same taxonomy node 408 may be repeated in the list 410 for each occurrence of a reference 402 that relates to it in the input document 401. Repeat instances of a taxonomy node 408 may have different confidence estimates 411 associated with them.

The list 410 is input into a focus determining means 412 which may be part of the mining application. The focus determining means 412 runs a focus algorithm 413 which allocates a score to the geographic place of each level in the hierarchy of a taxonomy node instance. The scores for each geographic place are added together to obtain an overall score for a geographic place. The one or more highest scoring geographic places are output as the overall focus or foci 414 of the input document 401. The means of determining the score are dependent on the specific algorithm used. However, each level of the hierarchy is allocated a progressively lower score.

The focus determining means 412 has parameter inputs 415 in the form of the function of score allocation used, the number of foci allowed per document, the threshold for scoring for a focus to be accepted and a decay constant for regional levels.

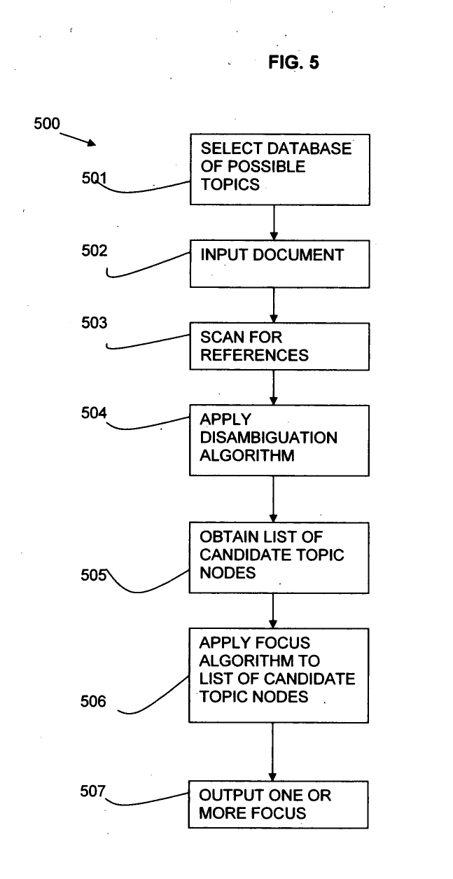

FIG. 5 shows a flow diagram of the method of determining the focus of a document 500. The method starts by selecting a database of possible topics 501. An document to be processed is then input 502 and scanned 503 to identify references to possible topics by comparing the references to the database of possible topics. A disambiguation algorithm 504 is applied to the references found. The disambiguation algorithm 504 determines the appropriate topic node for the reference and determines a confidence estimate for the topic node.

When a complete list of topic nodes which are candidates for the focus of the input document has been produced 505, the focus algorithm 506 is applied to the list and one or more foci of the input document are determined 507.

Details of the focus algorithm are described in more detail below.

For an instance of a taxonomy node of the form A/B/C whose disambiguation confidence is p (0=p=1), the score S(p) is allocated. The enclosing region of B/C is then allocated a score of S(p)d where 0<d<1 and d is the decay factor for enclosing regions. The enclosing region of C is then allocated a score of S(p)d².

After sorting all the resulting taxonomy nodes by score, they are looped over from highest to lowest, stopping at the low threshold or stopping if sufficiently many foci have been found. Levels in taxonomy nodes that cover or are covered by a level already selected as a focus are skipped (i.e. levels that have a parent-child relationship with an already selected focus). Otherwise, the taxonomy level is added to the list of foci.

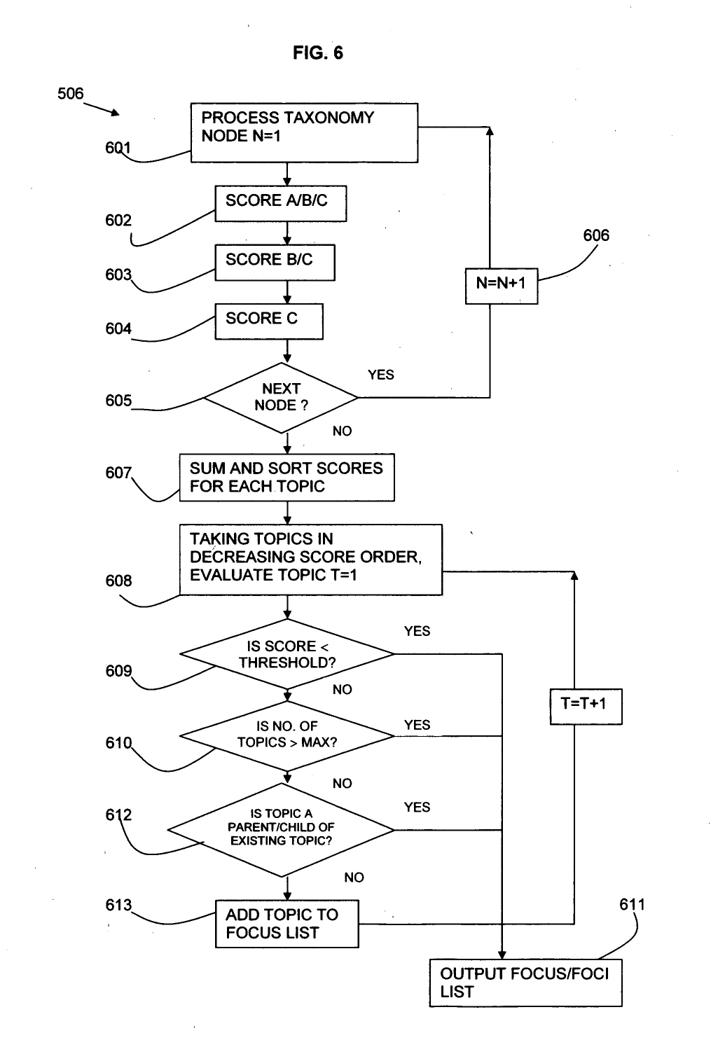

Referring to FIG. 6, a flow diagram showing the focus determination algorithm provided at step 506 of the flow diagram of FIG. 5 is provided. The flow diagram is provided for a list of taxonomy nodes with a maximum of three levels of hierarchy A/B/C.

A first taxonomy node in the list is processed 601. A score is obtained 602 for the lowest level of taxonomy node A/B/C. A score is then obtained 603 for the next level of taxonomy node B/C with a decay factor incorporated. A score is then obtained 604 for the highest level of taxonomy node C with a further decay incorporated. It is then determined if there is a next taxonomy node in the list 605 and, if so, the scoring is repeated for each taxonomy node in the list by looping 606 and repeating the scoring method.

Three levels of hierarchy are used in this example. Any number of levels of hierarchy may be used with a score being allocated to each level.

When all the topics in the levels of the taxonomy nodes have been scored, the scores for each topic are summed and sorted 607 by decreasing score. It is then determined for each topic in decreasing score order 608, if a threshold score has been obtained 609 and if a maximum number of foci have been obtained 610. It is also determined if a topic is a parent or child of a topic that has already been chosen as a focus 612. If the score is less than the threshold, the number of already chosen foci is less than the maximum allowed, and the topic is not a parent or child of an existing focus, the topic is added to the list of foci 613. The final list of zero, one or more foci which is then pushed as the output 611.

The focus algorithm loops over the disambiguated geographic places found in the input document, aggregating the importance of the various levels of the taxonomy nodes.

In an example embodiment of the focus algorithm, the function of scoring S(p) is chosen arbitrarily as S(p)=p² and the decay factor, d=0.7. The score threshold is set at 0.9 and a maximum of 4 foci are permitted.

The aforementioned weights and thresholds are based on some experimentation, and the method should not be construed as being restricted to these specific choices of values.

Also, while it is stated that the decay factor should be explicit in the algorithm, it is not limited to being 0.7, or to being a constant at all. In an alternative example embodiment, a decay factor from A/B/C to B/C may be chosen which is a function of the relative importance of A inside B/C. For example, the decay factor might be a function of the ratio of A/B/C's population to that of B/C, or statistical data may be used obtained from corpora regarding the frequency of mention of A/B/C compared to B/C.

The following is the pseudo code for the focus algorithm using the example embodiment parameters:

```
function S(p) = p²
function find_focus (d in [0,1], threshold, maxfoci)
  for each geotag assigned A/B/C with confidence p in [0,1]
    score(A/B/C) += S(p)
    score(B/C) += S(p) d
    score(C) += S(p) d²
  nodes = nodes_in_decreasing_score (score)
  i = 0
  foci = ( )
  while score(nodes(i)) > threshold and len (foci) < maxfoci
  unless covers (nodes(i),foci) or covered (nodes(i),foci)
    push foci [symbol] nodes(i)
  i = i + 1
```

An example using the geographic places shown in the tree hierarchy 300 of FIG. 3 is now described. An example input document contains four mentions of “Orlando/Florida/United States/North America” (with confidence 0.5), three “Texas/United States/North America” (0.75), eight “Fort Worth/Texas/United States/North America” (0.75), three “Dallas/Texas/United States/North America” (0.75), one “Garland/Texas/United States/North America” (0.75), and one “Iraq/Asia” (0.5).

A human asked to judge the geographic focus of the input document and would be likely to respond with “It's about Texas and perhaps also Orlando”. Indeed, the input document is a page from the “Orlando Weekly” site, in a forum titled “Just a look at The Texas Local Music Scene...”. A focus algorithm should reproduce this human decision. The focus algorithm gives the following scores for the taxonomy nodes of the input document:
6.41 Texas/United States/North America
4.97 United States/North America
4.50 Fort Worth/Texas/United States/North America
3.48 North America
1.68 Dallas/Texas/United States/North America
1.00 Orlando/Florida/United States/North America
0.69 Florida/United States/North America
0.56 Garland/Texas/United States/North America
0.25 Iraq/Asia
0.17 Asia

The focus algorithm proceeds to go over this sorted list from the top. Texas got the top score (because several separate cities - Fort Worth, Dallas and Garland contributed to it, even though each city contributed more to its own score) and is chosen as a focus. The next highest scorer, the United States, already covers Texas so it is dropped. The next scorer, Fort Worth, is covered by Texas and is dropped for the same reason, as are North America and Dallas which follow it in the list. Orlando/Florida does not cover the existing focus of Texas nor is it covered by it, and is taken as a second focus. The remaining scores (e.g., for Iraq/Asia) are below the importance threshold (0.9 in the example embodiment) and are ignored. This input document therefore ends up with two foci: Texas and Orlando, with Texas being the first (stronger) focus.

In summary, the focus-determination algorithm is given a list of geographic references in a document, together with the correct meaning of each reference as chosen from a gazetteer. The algorithm then attempts to decide which geographic references are incidental, and which constitute the actual focus of the document. A general, non-geographic case is similar—the algorithm gets a list of words or phrases that refer to various topics chosen from a given hierarchy of topics, and determines the topic or topics that the document is focusing on.

The described method may be applied in a mining application which finds mentions of geographic places (cities, states, countries and continents) in free-text Web pages, and then disambiguates the meaning of each mention: Is a specific mention of “London” referring to London, England, to London, Ontario (a city of 300,000 in Canada), or to something non-geographic as in “Jack London”? The list of known places from which these meanings are chosen is given in a gazetteer which lists all known geographic places as a hierarchy of cities, states, countries and continents. Next, the application finds a geographic focus of the entire document. The focus of the document is defined as a place (or a small number of places) that the document mainly discusses. Knowing this focus might be useful, for example, if the user wants to search for documents about California, rather than finding the multitude of documents that mention in passing some city in California or documents that list all the states of the union.

The described method has the advantage that it calculates the importance of the parent nodes of all levels in a hierarchy, so skipping two levels to determine a focus occurs naturally.

The algorithm also allows more-specific places to be declared as focus despite the mention of more general (larger) regions. For example, in a document with 10 mentions of London, 1 of Manchester and 1 of England, the algorithm can decide that London is the focus, not England. This is achieved by having the contribution decay up the hierarchy: a mention of London contributes more to the focus strength of London than to that of England. In the described algorithm, the decay is explicit, 70% per level, in the described embodiment.

The algorithm also ensures that only one of the regions in a hierarchy remains in the final focus set. The region that remains is the one deemed the most important by the algorithm.

The present invention is typically implemented as a computer program product, comprising a set of program instructions for controlling a computer or similar device. These instructions can be supplied preloaded into a system or recorded on a storage medium such as a CD-ROM, or made available for downloading over a network such as the Internet or a mobile telephone network.

Improvements and modifications can be made to the foregoing without departing from the scope of the present invention.

1. A method for determining the focus of a document, comprising:
providing candidate topics in the form of topic nodes in a hierarchy of topics;
for each candidate topic node, allocating a score to the topic of each level of the hierarchy of the topic node;
summing the scores for each topic; and
determining one or more topics as the focus of the document based on the scores.

2. A method as claimed in claim 1, wherein allocating a score to the topic of each parent level of the hierarchy of the topic node allocates a progressively lower score for the topic of each parent level of the hierarchy of the topic node.

3. A method as claimed in claim 1, wherein the method includes:
identifying occurrences of references to a topic in a document;
providing a plurality of possible topics in the form of topic nodes in a hierarchy of topics;
for each identified occurrence of a reference to a topic, determining the appropriate topic node; and
adding the topic node to the candidate topics.

4. A method as claimed in claim 3, wherein determining the appropriate topic node provides an indication of the level of confidence that the reference relates to the topic node and the allocating a score is based on the level of confidence.

5. A method as claimed in claim 1, wherein determining one of more topics as the focus of the document includes selecting a predetermined number of topics with the highest scores.

6. A method as claimed in claim 1, wherein determining one of more topics as the focus of the document includes selecting topics with a score above a predetermined threshold.

7. A method as claimed in claim 1, wherein determining one of more topics as the focus of the document includes disregarding topics in a hierarchy above or below a topic already selected as a focus.

8. A method as claimed in claim 3, wherein providing a plurality of possible topics in the form of topic nodes in a hierarchy of topics includes providing a list of possible forms of reference for each topic .

9. A method as claimed in claim 3, wherein determining the appropriate topic node includes disambiguating references to a topic.

10. A method as claimed in claim 9, wherein disambiguating references to a topic is carried out by applying heuristics to each reference to a topic including one or more of:
evaluating the words surrounding a reference;
applying additional information stored in relation to predefined references; and
evaluating a context of the reference in the document.

11. A method as claimed in claim 1, wherein the topics are geographic topics and the topic hierarchies include encompassing regions.

12. A system for determining the focus of a document, comprising:
means for providing candidate topics in the form of topic nodes in a hierarchy of topics;
means for allocating a score for each candidate topic node to the topic of each level of the hierarchy of the topic node;
means for summing the scores for each topic; and
means for determining one or more topics as the focus of the document based on the scores.

13. A system as claimed in claim 12, wherein the means for allocating a score to the topic of each parent level of the hierarchy of the topic node allocates a progressively lower score for the topic of each parent level of the hierarchy of the topic node.

14. A system as claimed in claim 12, wherein the system includes:
means for identifying occurrences of references to a topic in a document;
a record of a plurality of possible topics in the form of topic nodes in a hierarchy of topics;
means for determining, for each identified occurrence of a reference to a topic, the appropriate topic node in the record; and
means for adding the topic node to the candidate topics.

15. A system as claimed in claim 14, wherein the means for determining for each identified occurrence of a reference to a topic, the appropriate topic node includes means for providing an indication of the level of confidence that the reference relates to the topic node and the means for allocating a score is based on the level of confidence .

16. A system as claimed in claim 12, wherein the means for determining one of more topics as the focus of the document includes means for selecting a predetermined number of topics with the highest scores.

17. A system as claimed in claim 12, wherein the means for determining one of more topics as the focus of the document includes means for selecting topics with a score above a predetermined threshold.

18. A system as claimed in claim 12, wherein the means for determining one of more topics as the focus of the document includes means for disregarding topics in a hierarchy above or below a topic already selected as a focus.

19. A system as claimed in claim 14, wherein the record of a plurality of possible topics in the form of topic nodes in a hierarchy of topics includes a list of possible forms of reference for each topic.

20. A system as claimed in claim 14, wherein the means for determining, for each identified occurrence of a reference to a topic, the appropriate topic node in the record includes means for disambiguating references to a topic.

21. A system as claimed in claim 20, wherein the means for disambiguating references to a topic applies heuristics to each reference to a topic including one or more of:
evaluating the words surrounding a reference;
applying additional information stored in relation to predefined references; and
evaluating a context of the reference in the document.

22. A system as claimed in claim 12, wherein the topics are geographic topics and the topic hierarchies include encompassing regions.

23. A system as claimed in claim 12, wherein the system is a text mining application and the document is a text document.

24. A system as claimed in claim 23, wherein the document is a web page.

25. A computer program product stored on a computer readable storage medium, comprising computer readable program code means for determining the focus of a document, the code means performing the steps of:
providing candidate topics in the form of topic nodes in a hierarchy of topics;
for each candidate topic node , allocating a score to the topic of each level of the hierarchy of the topic node;
summing the scores for each topic; and
determining one or more topics as the focus of the document based on the scores.
